(19) United States
(12) Patent Application Publication
(10) Pub. No.: US 2015/0065589 A1
(43) Pub. Date: Mar. 5, 2015

(54) COMPOSITIONS COMPRISING POLY(TRIMETHYLENE TEREPHTHALATE) AND THERMOPLASTIC POLYOLEFIN AND PROCESSES USING THE COMPOSITIONS

(71) Applicant: E I DU PONT DE NEMOURS AND COMPANY, Wilmington, DE (US)

(72) Inventors: Geraldine M. Lenges, Wilmington, DE (US); Paul A. Colose, II, Wilmington, DE (US)

(73) Assignee: E I Du Pont de Nemours and Company, Wilmington, DE (US)

(21) Appl. No.: 14/394,744

(22) PCT Filed: Apr. 19, 2013
(86) PCT No.: PCT/US13/37351

§ 371 Date: Oct. 16, 2014

Related U.S. Application Data
(60) Provisional application No. 61/637,329, filed on Apr. 24, 2012.
(60) Provisional application No. 61/637,333, filed on Apr. 24, 2012.

(51) Int. Cl. C08J 11/06; C08J 3/20

(52) U.S. Cl. CPC C08J 11/06; C08J 3/203; C08J 2323/14; C08J 2467/02; C08J 2433/14
USPC 521/47

(57) ABSTRACT

This invention pertains to compositions and processes suitable for recycling post-consumer carpet tiles that comprise poly(trimethylene terephthalate) fibers and thermoplastic polyolefin backings. The compositions disclosed herein comprise poly(trimethylene terephthalate) and thermoplastic polyolefins, compositions which may or may not be mineral filled. Strong tough articles can be prepared by molding or extrusion of typical commercially available carpet tiles when combined with additional amounts of thermoplastic polyolefin, whether filled or unfilled.

### RELATED APPLICATIONS

This patent application is related to U.S. patent application Ser. No. 61/637,329 filed on Apr. 24, 2012 as CL5711, and U.S. patent application Ser. No. 61/637,333 filed on Apr. 24, 2012 as CL5721.

### FIELD OF THE INVENTION

This invention pertains to compositions and processes suitable for recycling post-consumer carpet tiles that comprise poly(trimethylene terephthalate) fibers and thermoplastic polyolefin backings.

### BACKGROUND

It is known to prepare compositions of thermoplastic olefins and polyethylene terephthalate) using compatibilizers such as EBAGMA. See for example, Benhamida et al., Macromolecular Engineering, DOI: 10.1002/mame.200900290.

Blends of PTT and other polyesters as well as polycarbonate are known in the art.

Paul et al., “Mechanical Behavior of Poly(Trimethylene Terephthalate)(PTT)-Polyolefin Blends for Thermoplastic Engineering Application,” General Poster Session, Materials Solutions Conference and Exposition (Oct. 18-21, 2004), Columbus, disclose blends of less than 50% by weight of LLDPE and PP in PTT prepared using a single screw extruder.

There is a compelling widespread interest in recycling of fabricated articles of commerce upon the conclusion of their useful life. Among the articles in widespread use is carpeting, including carpet tiles. A relatively recent addition to the marketplace are carpet tiles comprising carpet fibers comprising poly(trimethylene terephthalate) such as those available under the trade name of Sorona®, available from the DuPont Company. Carpet tiles will typically have fibers made from poly(trimethylene terephthalate) and a backing sheet comprising a thermoplastic olefin or other backing, often highly filled with an inorganic filler such as CaCO₃. It will be particularly useful to have a technology for recycling carpet tiles into useful products.

### SUMMARY OF THE INVENTION

In one aspect, the present invention provides a composition comprising a homogeneous mixture of 80 to 99% by weight of a thermoplastic polyolefin (TPO) and 20 to 1% by weight of poly(trimethylene terephthalate) (PTT), with respect to the total weight of the thermoplastic olefin plus the poly(trimethylene terephthalate).

In another aspect, the present invention provides a process comprising subjecting a multi-layer article to diminution to form pieces t of a size compatible with the feeding requirements of a melt compounder; feeding the pieces to the melt compounder; causing the pieces to undergo melting in the melt compounder to form a melt; subjecting the melt to mixing under the application of shearing forces; mixing the melt for a period of time necessary for the melt to become homogeneous; and, causing the melt to be removed from the melt compounder; wherein the multi-layer article comprises a thermoplastic polyolefin and poly(trimethylene terephthalate).

### BRIEF DESCRIPTION OF THE DRAWING

FIG. 1 depicts the construction of the carpet tile employed in the examples.

### DETAILED DESCRIPTION

When a range of values is provided herein, it is intended to encompass the end-points of the range unless specifically stated otherwise. Numerical values used herein have the precision of the number of significant figures provided, following the standard protocol in chemistry for significant figures as outlined in ASTM E29-08 Section 6. For example, the number 40 encompasses a range from 35.0 to 44.9, whereas the number 40.0 encompasses a range from 39.50 to 40.49.

As used herein, the term “copolymer” refers to a polymer comprising two or more chemically distinct repeat units, such as, for example, dipolymers, terpolymers, and tetrapolymers.

As used herein, the term “homogeneous” means that visual examination of a cross-section of a shaped article of the blend does not reveal evidence of distinctive domains that differ in composition.

As used herein, the term “tough” refers to a test specimen exhibiting an elongation to break of 50% or greater. The term “flexible” refers to the mode of failure when a 2 mm thick molded plaque is manipulated. A flexible specimen is observed to undergo at least 20 repeated, back and forth bends without failure. In contrast, a brittle sample, not of the invention, will undergo brittle failure on the first attempt to bend a ⅛″ thick molded plaque.

When polymer compositions are recited herein, it is specified that the concentration of PTT and TPO are expressed as percentages of the total weight of the polymer, namely of the sum of the weights of PTT and TPO. As discussed in more detail, infra, the TPO as used in the art of carpet tiles is typically heavily filled or loaded with inorganic filler, usually CaCO₃. In those instances in which the TPO is filled with inorganic filler, it is only the weight of the TPO polymer component, and not the weight of the CaCO₃ filler, that is included in the calculation of weight percentages in the polymer composition.

As used herein, the term multi-layer article refers to an article comprising at least two layers, one of which is rich in a suitable TPO, and the other of which is rich in PTT. The TPO can be, but need not be, filled with an inorganic filler dispersed throughout. In one embodiment of the multi-layer article , the PTT-rich layer consists essentially of PTT fibers that are adhered to the TPO layer which is in the form of a sheet.

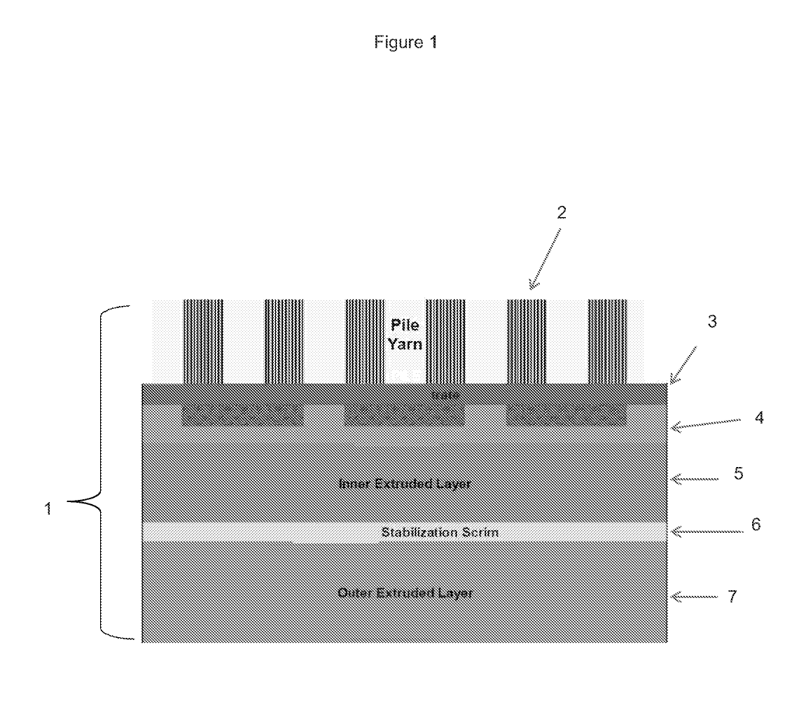

In one embodiment, a suitable multi-layer article is a carpet tile. Carpet tiles typically have additional layers, such as that depicted in FIG. 1, and described infra.

In one aspect, the present invention provides a composition comprising a homogeneous mixture of 80 to 99% by weight of a thermoplastic polyolefin and 20 to 1% by weight of poly(trimethylene terephthalate), with respect to the total weight of the thermoplastic olefin plus the poly(trimethylene terephthalate).

In one embodiment of the composition, the composition comprises 85 to 99% by weight of thermoplastic polyolefin and 15 to 1% by weight of poly(trimethlene terephthalate). In a further embodiment, the composition comprises a homogeneous mixture of 90 to 99% by weight of the thermoplastic polyolefin and 10 to 1% by weight of poly(trimethlene terephthalate).

In one embodiment, the thermoplastic olefin is a thermoplastic olefin elastomer. Suitable thermoplastic olefins include but are not limited to ethylene methylacrylate, ethylenebutyl acrylate ethylene ethylene acrylate, ethylene vinyl acetate, ethylene methacrylic acid (EMAA), ethylene acrylic acid (EAA), and EMAA and EAA that are partially neutralized with zinc and sodium salts.

In one embodiment, the thermoplastic olefin is a melt blend of an ethylene/propylene copolymer and polypropylene homopolymer. In a further embodiment, the melt blend is a 1:1 by weight blend of ethylene/propylene copolymer and polypropylene homopolymer.

Compatibilizing agents for blends of polyolefins with polyethylene terephthalate) are well known in the art. Copolymers of ethylene and glycidyl methacrylate have been used extensively for that purpose. Of particular value is a terpolymer of ethylene, butyl acrylate, and glycidyl methacrylate, known as EBAGMA. EBAGMA is available under the trade name Elvaloy® from the DuPont Company.

Addition of compatibilizing agent represents an undesirable added cost. It is a particularly surprising aspect of the present invention that at compositions in which the PTT concentration in the blend with a TPO is 10% or less by weight based upon the total weight of polymer, a suitably tough, flexible melt blend is prepared without resort to a compatibilizing agent (isn't this the one with 25% Tile: 75% TPO . . . assuming you calculated based on actual PTT). As the concentration of PTT in the blend is increased, the need for addition of a compatibilizing agent, preferably EBAGMA, is observed to increase. It is anticipated that achieving suitable toughness and flexibility in compositions comprising amounts of PTT>10%, particularly >15% will require use of compatibilizing agent.

PTT suitable for the practice of the invention includes both PTT homopolymer and PTT copolymers comprising up to 30 mol-% of monomer units of one or more comonomers. Preferred are PTT homopolymers. PTT is itself 2 monomers from a condensation reaction

In most carpet tiles, the TPO is filled with an inorganic filler, in particular with CaCO₃. It is well known in the art that inorganic fillers cause embrittlement in polymers unless they are surface treated to diminish adhesion between the polymer matrix and the filler. See for example Moss, U.S. Pat. No. 4,698,372. For this reason, it is important that the CaCO₃ employed in the TPO be combined with a surface treatment agent, as described in Moss, ibid. Suitable surface treatment agents include fatty acids, particularly stearic acid.

While the CaCO₃ concentration is not considered significant for the operability of the invention, it is found that the invention is operable when the TPO contains loadings of as much as 50% by weight, even 67% by weight of CaCO₃, based upon the total weight of the TPO and the CaCO₃.

In one embodiment, the composition comprising a homogeneous mixture of 80 to 99% by weight of a blend of ethylene/propylene copolymer and propylene, and 20 to 1% by weight of poly(trimethylene terephthalate), with respect to the total weight of the thermoplastic olefin plus the poly(trimethylene terephthalate); EBAGMA; and CaCO₃ at a concentration of at least 50% by weight with respect to the total weight of the blend of ethylene/propylene and propylene plus CaCO₃.

In another aspect, there is provided a process comprising subjecting a multi-layer article to diminution to form pieces t of a size compatible with the feeding requirements of a melt compounder; feeding the pieces to the melt compounder; causing the pieces to undergo melting in the melt compounder to form a melt; subjecting the melt to mixing under the application of shearing forces; mixing the melt for a period of time necessary for the melt to become homogeneous; and, causing the melt to be removed from the melt compounder; wherein the multi-layer article comprises a thermoplastic polyolefin and poly(trimethylene terephthalate).

Because it is impractical to feed typical carpet tiles into melt processors, it is necessary to subject them to diminution. Any process is suitable, such as chopping, shredding, or cryogenic grinding. The particular size of resultant particles required will be determined by the geometry of the feed into the processing unit to be employed, and the practicalities of operation.

In one embodiment of the process, wherein the PTT concentration in the multi-layer article exceeds 20% by weight, in a further embodiment, exceeds, 15% by weight, in a still further embodiment, exceeds 10% by weight, the process further comprises addition of further amounts of TPO—either filled or unfilled—to adjust the concentration of PTT to be ≦20% by weight, preferably ≦15% by weight, most preferably ≦10% by weight.

In one embodiment, the process further comprises addition of a compatibilizing agent to the melt, where in the compatibilizing agent is suitable for use in compatibilizing melt blends of thermoplastic polyolefins and polyesters. Such agents are well known in the art, and are available commercially; however, their suitability for use in blends of PTT and TPO was not known prior to the present invention. Suitable compatibilizing agents include but are not limited to copolymers of ethylene and glycidyl methacrylate Particularly preferred are terpolymers of ethylene, butyl acrylate, and glycidyl methacrylate, known as EBAGMA.

Melt compounding to form the blend can be achieved using any method and equipment such as is known in the art. Both batch and continuous processing are suitable. However, so-called high shear mixers are preferred. Suitable high shear mixers include, for example, Farrell Continuous Mixers, co-rotating twin screw extruders, and Brabender mixers. Single screw extruders may in some configurations be suitable but are not preferred.

The particular temperatures and residence times required to achieve the desired degree of homogeneity will depend upon the particular ingredients, and the desired end use properties.

In one embodiment, the process further comprises forming the melt into a shape, followed by quenching to form a shaped article. Suitable shaped articles include molded articles, and extruded sheets. In one particularly preferred embodiment, the melt blend prepared according to the process is extruded as a back sheet to a carpet in the manufacture of carpet tiles.

The invention is further described in but not limited by the following specific embodiments.

### EXAMPLES

### Starting Materials

In each example and comparative example following, an actual chopped and shredded carpet tile was employed as a feed to the extruder, as described below. The carpet tile so employed is depicted in FIG. 1. The carpet tile, 1, consisted of 1400 denier melt spun BCF (bulk continuous filament) carpet yarns, 2, made from 100% PTT, were tufted into a 3.5 oz/sq.yd, non-woven substrate, 3, to form a tufted fabric with a 24 oz/sq.yd, face fiber density. The thus tufted carpet was subject to coating with a latex dispersion of vinyl acetate ethylene and CaCO₃ to form a 23 oz/sq.yd.VAE precoat, 4. The thus prepared precoated structure was then extrusion coated with TPO containing 67% by weight of CaCO₃ to form a 27.3 oz/sq.yd. layer, 5. A 2 oz/sq.yd. fiberglass scrim, 6, was then applied to the TPO layer. Finally a second TPO layer was applied onto the fiberglass scrim, forming a second 27.3 oz/sq.yd.TPO layer

The thus prepared carpet tile, was then subject to room temperature shredding and chopping to form a mixture of coarse granules approximately 6 mm×12 mm×12 mm in dimension.

Virgin TPO containing 67% CaCO₃ by weight was obtained as 1A147 from Lyondell-Bassell.

EBAGMA was obtained from the DuPont Company as Elvaloy.

### Extrusion

The ingredients listed in Table 2 in the proportions shown were separately weight-loss fed to the feed throat of a 30-mm Werner-Pfleiderer (ZSK-30) co-rotating twin-screw extruder with electrically heated barrels, once-through cooling water and provided with vacuum ports. The extruder profile was set as shown in Table 2. The melt probe temperature refers to a periodic measurement using a thermocouple inserted by hand into the extruding melt.

TABLE 1

| | Tile | Virgin | |
|---|---|---|---|
| | Granules | TPO | EBAGMA |
| Example | (wt-%) | (wt-%) | (wt-%) |
| Comparative Ex. A | 100 | 0 | 0 |
| Comparative Ex. B | 0 | 100 | 0 |
| Example 1 | 25 | 75 | 0 |
| Example 2 | 50 | 50 | 0 |
| Example 3 | 75 | 25 | 0 |
| Example $ | 75 | 20 | 5 |
| Example 5 | 90 | 10 | 0 |
| Example 6 | 90 | 5 | 5 |

TABLE 2

| | Zone | | | | | | | | | | Melt |
|---|---|---|---|---|---|---|---|---|---|---|---|
| | 1 | 2 | 3 | 4 | 5 | 6 | 7 | 8 | 9 | Die | Probe |
| Temperature | RT | 250 | 240 | 240 | 240 | 240 | 220 | 220 | 220 | 220 | 222-253 |
| Set Point (° C.) | | | | | | | | | | | |

The extrusion die was a single strand die with a 4.8 mm hole. Total extruder throughput was maintained at 10 pounds per hour. Screw speed was 125 rpm, using a #4 medium working screw.

The melt strand was drawn from the strand die and immersed within a distance of about 100 mm into a chilled water quench bath from which it was directed to a pelletizer where the thus quenched strand was cut into pellets approximately 3 mm in size.

### Molding

The pellets so prepared were injection molded into 4-mm ISO bars and 2-mm ISO plaques (60-cm by 60-cm) using a 1.5-oz. Arburg Allrounder 221K/38-ton injection molding machine. The extruder and nozzle were set at 170° C. for all samples. The mold was not heated. In the case of the molded plaques, the injection time was 15 seconds, and the hold time was 15 seconds. Cycle time was 37.2 seconds. In the case of the molded bars, injection time was 10 seconds, and the hold time was 10 seconds. Cycle time was 25.8 seconds. Mold release was employed.

### Physical Properties

Physical properties were determined according to MTS ISO 527-2. Each datum represents the average of 5 test specimens. Results are shown in Tables 3 and 4.

TABLE 3

| | Tensile | | Tensile | |
|---|---|---|---|---|
| | Strength | Young's | Elongation | CTE |
| | Stress @ | Modulus | Strain @ | Alpha |
| Example | Max | kpsi | Break % | (μm/(m*° C.)) |
| Comp Ex. B | 639 | 44.0 | 160.3 | 124.7 |
| Example 1 | 629 | 81.6 | 64.1 | 118 |
| Example 2 | 684 | 118.7 | 6.3 | 113.8 |
| Example 3 | 705 | 129.4 | 4.9 | 109.7 |
| Example 5 | 689 | 125.9 | 8.1 | 110.9 |
| Comp. Ex. A | 967 | 174.6 | 1.605 | 104.1 |

TABLE 4

| | Tensile Elongation | Young's | | |
|---|---|---|---|---|
| | Strain @ | Modulus | Shore | |
| Example | Break % | kpsi | Hardness | CTE |
| Example 3 | 4.9 | 129.4 | 45 | 109.7 |
| Example 4 | 9 | 71.6 | 38 | 130.8 |
| Example 5 | 8.1 | 125.9 | 47 | 110.9 |
| Example 6 | 9.5 | 66.3 | 37 | 144.4 |

1. A process comprising subjecting a multi-layer article to diminution to form pieces t of a size compatible with the feeding requirements of a melt compounder; feeding said pieces to said melt compounder; causing said pieces to undergo melting in said melt compounder to form a melt; subjecting said melt to mixing under the application of shearing forces; mixing said melt for a period of time necessary for the melt to become homogeneous; and, causing said melt to be removed from said melt compounder; wherein said multi-layer article comprises a thermoplastic polyolefin and poly(trimethylene terephthalate).

2. The process of claim 1 wherein the thermoplastic polyolefin is present at a concentration of 80 to 99% by weight, and the poly(trimethylene terephthalate) is present at a concentration of 20 to 1% by weight, with respect to the total weight of the thermoplastic olefin and the poly(trimethylene terephthalate).

3. The process of claim 2 further comprising forming the melt into a shape followed by quenching the shaped melt to form a shaped article.

4. The process of claim 3 wherein the shaped article is a film or sheet.

5. The process of claim 4 wherein the film or sheet is a carpet backing sheet.

6. The process of claim 1 further comprising adding to the melt a compatibilizing agent suitable for use in compatibilizing melt blends of thermoplastic polyolefins and polyesters.

7. The process of claim 6 wherein the compatibilizing agent comprises a polymer comprising monomer units derived from ethylene and glycidyl methacrylate.

8. The process of claim 1 wherein the multi-layer article further comprises an inorganic filler.

9. The process of claim 1 wherein the thermoplastic polyolefin is a thermoplastic polyolefin elastomer which is a copolymer of ethylene and a higher alkene.

10. The process of claim 20 wherein the higher alkene is propylene.

11. A composition comprising a homogeneous mixture of 80 to 99% by weight of a thermoplastic polyolefin and 20 to 1% by weight of poly(trimethylene terephthalate), with respect to the total weight of the thermoplastic olefin plus the poly(trimethylene terephthalate).

12. The composition of claim 1 further comprising a compatibilizing agent.

13. The composition of claim 4 wherein the compatibilizing agent comprises a polymer comprising monomer units derived from ethylene and glycidyl methacrylate.

14. The composition of claim 1 further comprising an inorganic filler.

15. The composition of claim 7 wherein the inorganic filler is CaCO₃ at a concentration of at least 50% by weight with respective to the total weight of the thermoplastic olefin plus CaCO₃.
